(19) United States
(12) Patent Application Publication
(10) Pub. No.: US 2010/0188309 A1
(43) Pub. Date: Jul. 29, 2010

(54) RADAR ANTENNA

(75) Inventors: Nobutake Orime, Tokyo (JP); Naotaka Uchino, Tokyo (JP); Daisuke Inoue, Tokyo (JP); Yoichi Iso, Tokyo (JP)

Correspondence Address: TUROCY & WATSON, LLP, 127 Public Square, 57th Floor, Key Tower, CLEVELAND, OH, 44114, US

(73) Assignee: THE FURUKAWA ELECTRIC CO., LTD, Tokyo (JP)

(21) Appl. No.: 12/411,796

(22) Filed: Mar. 26, 2009

(30) Foreign Application Priority Data
Jan. 26, 2009 (JP) 2009-13850

(51) Int. Cl. H01Q 1/48; H01Q 1/52; H01Q 1/36

(52) U.S. Cl. 343/841; 343/848

(57) ABSTRACT

Provided is a radar antenna integrally formed on a dielectric radiation board to prevent occurrence of surface wave and capable of wide angle measurement. The radar antenna 400 has eight antenna units 410 formed on a radiation board 420 in 4 by 2 arrangement. On a back surface of the radiation board 420, a first ground plate 401 is formed, and a line board 405 is further formed on the first ground plate 401. A radiation part 402a is pattern-formed on the radiation board 420 and a power feeding part 402b is formed to be a through hole and connected to a transmission line 404. A second ground plate 403 has a land 403a pattern-formed on the radiation board 420 and a through hole 403b.

### CROSS-REFERENCE TO RELATED APPLICATIONS

This application claims priority to Japanese patent application No. 2009-13850, filed on Jan. 26, 2009, the entire content of which is incorporated herein by reference.

### TECHNICAL FIELD

The present invention relates to an antenna used in a vehicle radar and particularly to the technical field of an radar antenna having wide-angle directivity.

### BACKGROUND OF THE INVENTION

Out of conventionally known antennas, a half-wavelength dipole antenna is known as an antenna of lowest directivity or an omnidirectional antenna. The half wavelength dipole antenna has two straight antenna elements arranged in a line and has a doughnut-shaped gain in a plane perpendicular to the antenna elements.

Besides, as an antenna similar to the half-wavelength dipole antenna, there is a ¼ wavelength monopole antenna in which only one of the two antenna elements of the dipole antenna is used and arranged vertically on a conductor plate (ground plate). With the ¼ wavelength monopole antenna, a mirror image of the ¼ wavelength antenna element arranged on the conductor plate is obtained diametrically opposed to the conductor plate, and when the conductor plate is infinitely wide, the ¼ wavelength monopole antenna and its mirror image can give almost the same performance as the half-wavelength dipole antenna.

Such dipole antenna and monopole antenna have been conventionally used as omnidirectional antennas. For example, the monopole antenna is widely used as an antenna mounted on a roof of a vehicle or an antenna for portable phone. In addition, a monopole antenna really used has a structure having a center conductor of a coaxial line used as an antenna element and an external conductor connected to a ground plate, for example.

Meanwhile, as a vehicle-mounted radar for detecting an obstacle or the like in the moving direction of the vehicle, there is known a radar having plural antennas arranged for measuring an azimuth angle of the obstacle or the like. For example, the patent document 1 discloses a radar antenna 900 as shown in FIG. 10. In the antenna 900, plural antenna units 902 each having a spirally formed antenna element 901 are arranged on a ground plate 903 to form an array antenna used for detecting the directional angle of an obstacle.

[Prior Art]

[PATENT DOCUMENT 1] Japanese Patent Application Laid-Open No. 2006-258762.

### SUMMARY OF THE INVENTION

### DISCLOSURE OF THE INVENTION

### Technical Problem

However, the antenna disclosed in the patent document 1 has strong directivity and can only receive signals of azimuth angles (for example, ±30 degrees) centering a direction perpendicular to the antenna surface. That is, this antenna has a problem of narrow angle measurement. Although it is preferable to use an antenna of wide directivity in order to broaden the measurement angle, for example, a dipole antenna or monopole antenna has another problem of incapability of specifying the angle due to its omnidirectivity.

In addition, when the antenna is formed integrally on the dielectric radiation board using a printed circuit board, and dimensions of the radiation board are not adequate, there occur surface waves, which cause distortion in a radiation pattern. Such distortion in the radiation pattern may cause another problem that there occurs ambiguity in discrete curve for direction finding in monopulse angle measurement.

The present invention was carried out to solve the above-mentioned problems and has an object to provide a radar antenna which has an integral structure formed on a dielectric radiation board to prevent occurrence of surface wave and is capable of wide angle measurement.

### Technical Solution

A first aspect of the present invention is a radar antenna comprising: a radiation board having a thickness of d3; a straight radiation part formed on one surface of the radiation board; a first ground plate formed on an opposite surface of the radiation board; a power feeding part formed passing perpendicularly through the radiation board, electrically connected to the radiation part and being out of contact with the first ground plate; a second ground plate formed in parallel with the power feeding part, a predetermined distance away from the power feeding part and extending from the one surface to the first ground plate; and the radiation part and the power feeding part forming an antenna element.

The radar antenna according to another aspect of the present invention is characterized in that when a free space wavelength of transmission/reception wave is λ0, a relative permittivity of the radiation board is εr, an effective relative permittivity of the radiation board is εeff and a width of the radiation part is w, a length of the radiation part satisfies equations (1) and (2).

$$\begin{matrix}L \approx \frac{λ eff}{4} = \frac{λ 0}{4 \sqrt{ɛ eff}} & ( Equation 1 ) \\ ɛ eff = \frac{ɛ r + 1}{2} + \frac{ɛ r - 1}{2 \sqrt{1 - 10 d 3 / w}} & ( Equation 2 )\end{matrix}$$

The radar antenna according to another aspect of the present invention is characterized in that the antenna element and the second ground plate form one antenna unit, the antenna unit comprises two antenna units arranged on the radiation board, and a distance between two antenna elements meets D/λ0<0.5.

The radar antenna according to yet another aspect of the present invention is characterized in that a plurality of antenna units are arranged and arrayed in a direction orthogonal to an arrangement direction of the two antenna units.

The radar antenna according to yet another aspect of the present invention is characterized by further comprising: a line board having one surface adhered to an surface of the first ground plate opposite to a surface in contact with the radiation board; a transmission line formed on an opposite surface of the line board; and the through hole of the power feeding part passing perpendicularly through the line board and electrically connecting the radiation part to the transmission line.

The radar antenna according to yet another aspect of the present invention is characterized in that the thickness d3 of the radiation board satisfies an equation (3).

$$d 3 < \frac{λ}{4 \sqrt{ɛ r - 1}} \qquad ( Equation 3 )$$

The radar antenna according to yet another aspect of the present invention is characterized in that when the thickness d3 of the radiation board is expressed by an equation (4), β satisfies 1.6<β<1.7.

$$d 3 = \frac{λ 0}{4 β \sqrt{ɛ r - 1}} 4 \qquad ( Equation 4 )$$

The radar antenna according to yet another aspect of the present invention is characterized in that the second plate has a land formed on the one surface of the radiation board and a through hole row having a plurality of through holes passing through the radiation board and electrically connecting the first ground plate and the land, and the through hole row is arranged the predetermined distance away from the power feeding part.

The radar antenna according to yet another aspect of the present invention is characterized in that the second ground plate has other plural through holes arranged into a ring shape farther from the power feeding part than the through hole row.

The radar antenna according to yet another aspect of the present invention is characterized in that the second ground plate has a part formed on the one surface of the radiation board having a height of α(≧0) and a height of the second ground plate from the first ground plate h is d3+α.

The radar antenna according to yet another aspect of the present invention is characterized by further comprising one or more boards between the radiation board and the line board, the one or more boards being stacked into a layer and having a bias line formed therein.

The radar antenna according to yet another aspect of the present invention is characterized by further comprising: another through hole row formed like a blind between the bias line and the antenna element; a sheet metal covering a surface of the radiation board positioned at a top of a bias layer where the bias line is arranged; and the through hole row and the sheet metal being electrically connected to reduce interference between the antenna element and the bias line.

### Effect of the Invention

As described above, according to the present invention, the antenna elements are suitably arranged on the dielectric radiation board to have an integral structure. With this structure, it is possible to provide a radar antenna capable of wide-angle measurement while preventing occurrence of surface waves.

### BRIEF DESCRIPTION OF THE DRAWINGS

FIG. 1 is a perspective view of a radar antenna according to a first comparative example;

FIG. 2 is a perspective view of the radar antenna according to the first comparative example, showing another surface of the radar antenna;

FIG. 3 is a side view of an antenna unit of the first comparative example;

FIG. 4 is a view schematically showing an antenna formed by changing the dipole antenna in shape;

FIG. 5 is a view showing reception pattern examples of a sum signal and a difference signal of an antenna element or antenna element body;

FIG. 6 a perspective view of a radar antenna according to a second comparative example;

FIG. 7 is a perspective view of a radar antenna according to a third comparative example;

FIG. 8 is a view schematically showing effect on the radiation pattern put by the height of the second ground plate;

FIG. 9 shows a perspective view and a cross sectional view of a radar antenna according to a first embodiment of the present invention;

FIG. 10 is a plane view of a conventional radar antenna;

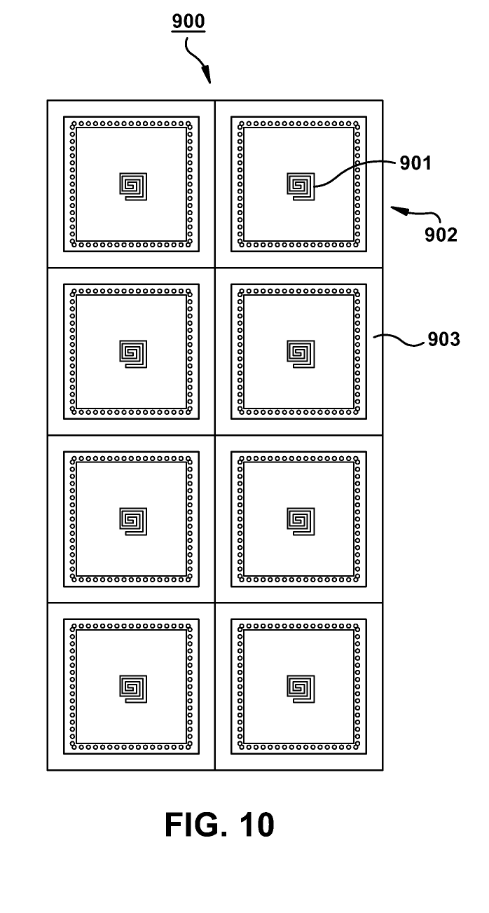

FIG. 11 shows an example of radiation pattern of the radar antenna of the first embodiment;

FIG. 12 is a view showing the relationship between the relative permittivity of the radiation board and d3/0λ;

FIG. 13 is a cross sectional view of one antenna unit of a radar antenna according to a second embodiment of the present invention; and

FIG. 14 is a partial cross sectional view of a radar antenna according to a third embodiment of the present invention.

### DESCRIPTION OF THE REFERENCE SYMBOLS

100, 400, 500, 900 radar antenna;

101, 401 first ground plate;

102, 402, 901 antenna element;

102a, 402a radiation part;

102b, 402b power feeding part;

103, 203, 303, 403 second ground plate;

104, 404 transmission line;

105, 405 line board;

110, 410, 450, 902 antenna unit;

420 radiation board;

451 reflector;

501 dielectric board;

502 radiation board;

503 bias line;

504 micro strip line;

505 third ground plate;

506 pattern;

507 through hole.

### DESCRIPTION OF THE PREFERRED EMBODIMENTS

With reference to the drawings, radar antennas according to preferred embodiments of the present invention will be described below. For simple illustration and explanation, components having identical functions are denoted by like reference numerals.

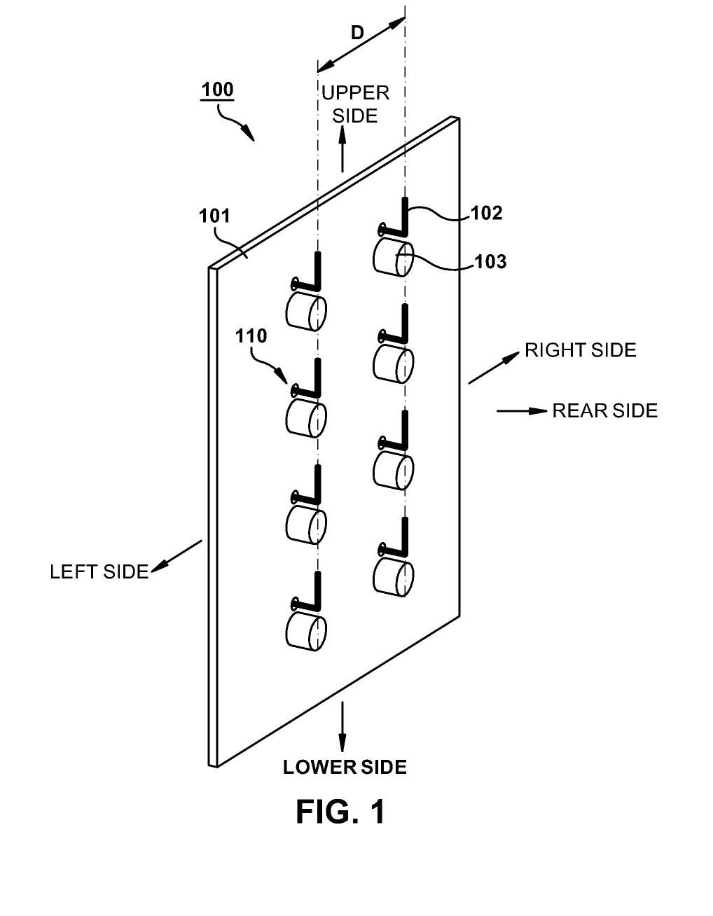

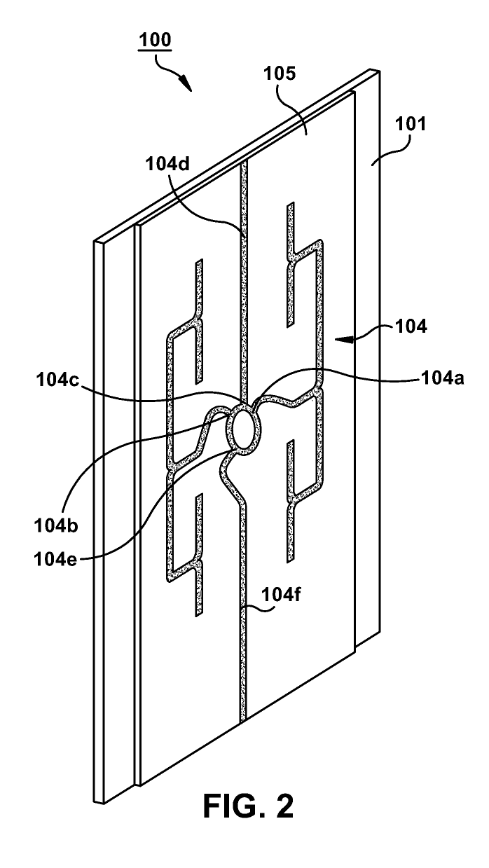

FIGS. 1 and 2 show perspective views of a radar antenna of a first comparative example. FIG. 1 is a perspective view showing a radiation-side surface of the radar antenna 100 of the first comparative example, while FIG. 2 is a perspective view showing an opposite surface to the radiation side surface of the radar antenna 100. In the one surface of the radar antenna 100, antenna elements 102 and second ground plates are arranged in pairs on a first ground plate 101. The second plates 103 are electrically connected to the first ground plate 101.

Besides, in the opposite surface of the radar antenna 100, a transmission line 104, which is connected to the antenna elements 102, is formed on a line board 105. The transmission line 104, together with the ground plate 101 and the line board 105, makes up a micro strip line.

In the radar antenna 100 shown in FIG. 1, the upper part of the first ground plate 101 is placed to the ceiling side of the vehicle, the lower part is placed to the wheel side, and the right part in the figure is placed to the rear side of the vehicle. In this comparative example, it is assumed that electric wave is emitted from each of the antenna elements 102 toward the rear part of the vehicle. An antenna element 102 and a second ground plate 103 form one pair. Two such pairs are arranged in the horizontal direction and four pairs are arranged in the vertical direction.

In this comparative example, a phase comparison monopulse system is used in order to measure an azimuth angle in the horizontal direction of a certain target positioned in the rear of the vehicle. In the phase comparison monopulse system, signals received by two antennas arranged horizontally are used as a basis, and a value obtained by standardizing a difference signal of the received signal by a sum signal the received signals is applied to a preset discrete curve (monopulse curve) thereby to obtain a deviation angle from the direction perpendicular to the antenna plane. In this comparative example, the azimuth angle measurement based on the phase comparison monopulse system is performed in such a manner that a sum of received signals of four antenna elements 102 arranged vertically to the left side and a sum of received signals of four antenna elements 102 arranged vertically to the right side are obtained and used as a basis to obtain a sum and a difference between the two sums.

Specifically, the sum of received signals of the left-side four antenna elements 102 in FIG. 1 is output to a line branch point 104a on the transmission line 104, and the sum of received signals of the right-side four antenna elements 102 is output to a line branch point 104b on the transmission line 104. The line length from the line branch point 104 to the line branch point 104c is formed equal to the line length from the line branch point 104b to the line branch point 104c. A sum signal of the sum of the received signals of the right-side antenna elements 102 and the sum of the received signals of the left-side antenna elements 102 is output from an output line 104d connected to the line branch point 104c.

On the other hand, the line length from a line branch point 104a to a line branch point 104e differs from the line length from a line branch point 104b and the line branch point 104e by a phase difference of 180 degrees. With this difference, a difference signal between the sum of the received signals of the right-side antenna elements 102 and the sum of the received signals of the left-side antenna elements 102 is output from an output line 104f connected to the line branch point 104e.

In the radar antenna 100 of this comparative example, the antenna elements 102 and the second ground plate 103 as shown in FIG. 1 are used thereby to realize an antenna capable of measurement over wide-angle range from the rear to right and left sides of the vehicle (hereinafter, the measurable angle range is called “cover area”). Here, an antenna element 102 and one second ground plate 103 are combined into an antenna unit 110 for the radar antenna 100, and the following description is made about the operation the operation of the antenna unit 110.

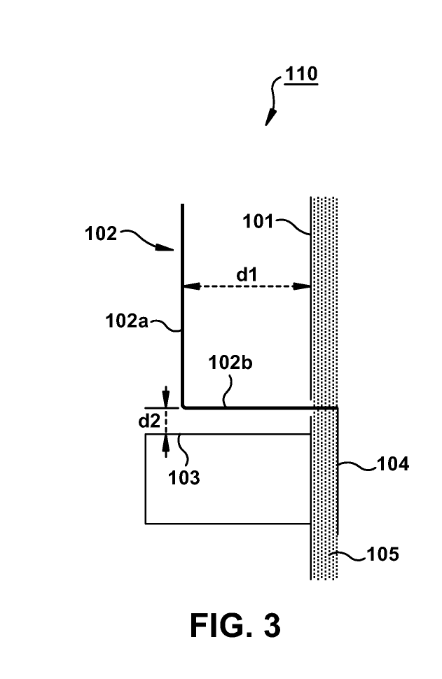

The antenna unit 110 of the radar antenna 100 is shown in FIG. 3. FIG. 3 is a side view showing the right side of any one of eight antenna units 110 of FIG. 1. The antenna element 102 is a linear antenna bent into L shape, and one end of the antenna is open and the other end passes through the first ground plate 101 out of contact with the first ground plate 101, then through the line board 105 and connected to the transmission line 104.

An open end side part of the antenna element 102 is arranged in parallel with the ground plate 101 and is called a radiation part 102a in the following description. Besides, the part connected to the transmission line 104 of the antenna element 102 is arranged in parallel with the second ground plate 103 and is called a power feeding part 102b.

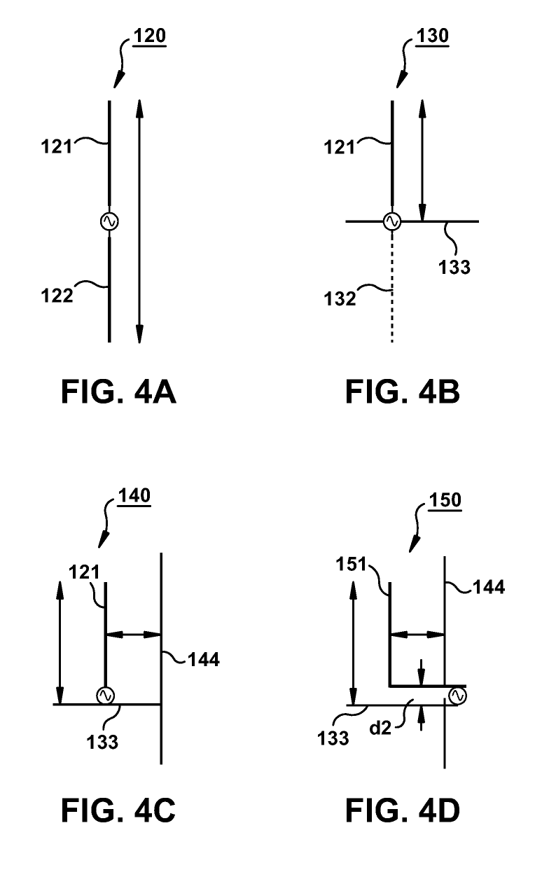

In the radar antenna 100 of this comparative example, in order to broaden the horizontal angle-measurable cover area, a dipole antenna which has omnidirectivity in principle is used as a basis and manufactured to have a backward directivity thereby to realize the fundamental functions of the antenna elements as the radar. In the following description, the schematic diagrams of FIGS. 4(a) to 4(d) are used to explain the operation of the antenna element 102 of this comparative example.

FIG. 4(a) is a schematic diagram showing a dipole antenna. When the transmission/reception electric wave has a wavelength of λ, the dipole antenna 120 has an antenna element 121 and an antenna element 122 which are made of linear conductor having a length of about λ/4 and arranged in a line. The whole length of the dipole antenna 120 is about λ/2 (half-wavelength dipole antenna). Such a dipole antenna 120 has the radiation pattern which centers the dipole antenna 120 and is doughnut shaped in the direction perpendicular to the dipole antenna 120. In this way, the dipole antenna 120 has the omnidirectional radiation pattern on the plane perpendicular thereto.

FIG. 4(b) is the schematic diagram of a monopole antenna. The monopole antenna 130 uses one antenna element (for example, 121) of the dipole antenna and the ground plate 133 is formed perpendicular to the antenna element 121. With this structure, the monopole antenna has antenna performance almost equivalent to the dipole antenna 120 as the mirror image 132 of the antenna element 121 is formed. Hence, as is the case with the dipole antenna 120, the monopole antenna 130 as shown in FIG. 4(b) forms the omnidirectional radiation pattern horizontally. The monopole antenna 130 has the whole length of about λ/4 (¼ wavelength monopole antenna) and the height of half the height of the dipole antenna 120. Hence, the monopole antenna 130 has a merit of space saving.

As to the radar mounted on a vehicle for detecting an object behind the vehicle, it needs such directivity as to emit electric wave only in the rear direction of the vehicle (direction opposite to the moving direction) not in the front direction. Then, in order to give backward directivity to the monopole antenna 130, the antenna shown in FIG. 4(c) has another ground plate 144 placed in parallel with the antenna element 121 and a given distance (d1) away from the antenna element. In this case, it is important that the ground plates 133 and 144 are electrically connected to each other. If they are not connected, there is generated a notch in the radiation pattern in the horizontally single direction (sharp drop of gain).

As the ground plate 144 is provided, the doughnut-shaped radiation pattern centering the antenna element 121 is changed to reflect wave on the ground plate 144 and prevent it from being emitted frontward. As a result, the antenna is obtained which utilizes a monopole antenna and has antenna property of backward directivity. In this way, as the ground plate 144 functions as a reflector for reflecting electric wave, the antenna shown in FIG. 4(c) is called a reflector-mounted monopole antenna below.

When the reflector-mounted monopole antenna 140 shown in FIG. 4(c) is used as an antenna corresponding to the antenna unit 110 provided in the radar antenna 100 of the first comparative example shown in FIG. 1, the ground plate 144 of the reflector-mounted monopole antenna 140 corresponds to the ground plate 101 of the radar antenna 100 shown in FIG. 1 and the ground plate 133 corresponds to the second ground plate 103.

In the radar antenna of the above-described second comparative example using the reflector-mounted monopole antenna 140 as antenna unit, power feeding to the antenna element 121 needs to be performed from the ground plate 133 as the second ground plate. However, as the transmission line 104 is formed on the opposite surface of the first ground plate 101, there is a need to add a transmission line for feeding power from the transmission line 104 to the antenna element 121 via the second ground plate 103 (ground plate 133).

FIG. 4(d) shows the antenna in which direct power feeding is allowed from the transmission line 104 to the antenna elements. The antenna element 151 of the antenna 150 shown in FIG. 4(d), the antenna element 121 is bent 90° toward the ground plate 144 at a given distance (d2) from the ground plate 133, and the bent part passes in parallel to the ground plate 133 through the opposite surface of the ground plate 144. With this structure, it becomes easy to connect the antenna element 151 to the transmission line formed on the opposite surface of the ground plate 144.

The radar antenna 100 of the first comparative example uses an antenna 150 shown in FIG. 4(d) as antenna unit 110. A part in parallel to the ground plate 144 of the antenna element 151 corresponds to the radiation part 102a shown in FIG. 3 and the remaining bent part in parallel to the ground plate 133 corresponds to the power feeding part 102b.

It is important to form the power feeding part 102 an appropriate distance d2 away from the second ground plate 103 so as to send high-frequency signals from the transmission line 104 to the radiation part 102a. Specifically, the distance d2 is adjusted in such a manner that a transmission line part is formed between the power feeding part 102b and the second ground plate 103 and impedance of the transmission line part seen from the transmission line 104 side is a predetermined value, thereby to allow power feeding from the transmission line 104 to the radiation part 102a effectively.

Next, description is made about the distance d1 between the radiation part 102a and the first ground plate 101. As described above, the ground plate 101 has the function as a reflector for preventing radiation of electric wave frontward. Then, the distance d1 from the radiation part 102a significantly affects the radiation pattern from the radiation part 102.

In the radar antenna 100, it is preferable to realize such a radiation pattern as to be able to obtain a predetermined gain or more over backward wide angle range (cover area). When the free space wavelength of the transmission/reception wave is λ0, the distance d1 is preferably set to λ0/4 or any close value in order to obtain the radiation pattern of high gain in the wide cover area.

In the description below, it is assumed that the azimuthal angle measured by the radar antenna 100 is expressed as an angle shifted from the reference (0°) of the direction vertical to the first ground plate 101. When the distance d1 is set to about λ0/4, the gain shows its peak at the azimuthal angle 0° and the gain decreases as the azimuthal angle is increased to the right or left side, which shows the monophasic gain pattern. Besides, when the distance d1 is shifted from λ0/4, the gain pattern can be changed to a diphasic one having a wider cover area. In this way, as the distance d1 is set to λ0/4 or its close value, a wider cover area can be obtained. For example, the cover area realized can be ±50° or greater for 3 dB beam width.

Next description is made about arrangement of the antenna units 110. In the monopulse system, signal values measured at two horizontally difference positions are used to obtain a sum signal and a difference signal of them and then to obtain the azimuthal angle. The directivity of the array antenna using the phase comparison monopulse system depends on the directivity of antenna elements and the directivity of arrangement of the antenna elements, which are both combined into a composite directivity as expressed by the following equation:

Composite directivity=directivity of antenna element×directivity of arrangement of omnidirectional point sources (where “x” refers to a multiplication operator)

From this equation, in order to realize, as the composite directivity, an angle-measuring cover area of ±90°, for example, it is necessary to use antenna elements having as wide a beam width as possible and to arrange the antenna elements in such a manner as to show wide directivity.

In the radar antenna 100, the antenna units 110 of the structure shown in FIG. 3 are used to broaden the directivity of the antenna elements 102. In addition, in order to broaden the directivity of arrangement of the antenna elements 102, one or more antenna units 110 are arranged on the same straight line (vertical line) as the antenna elements 102 (four antenna elements in FIG. 1) to be an array, and when the distance between the horizontally arranged arrays is D as shown in FIG. 1, the antenna elements 102 (and antenna units 110) are arranged to meet D/λ0<0.5.

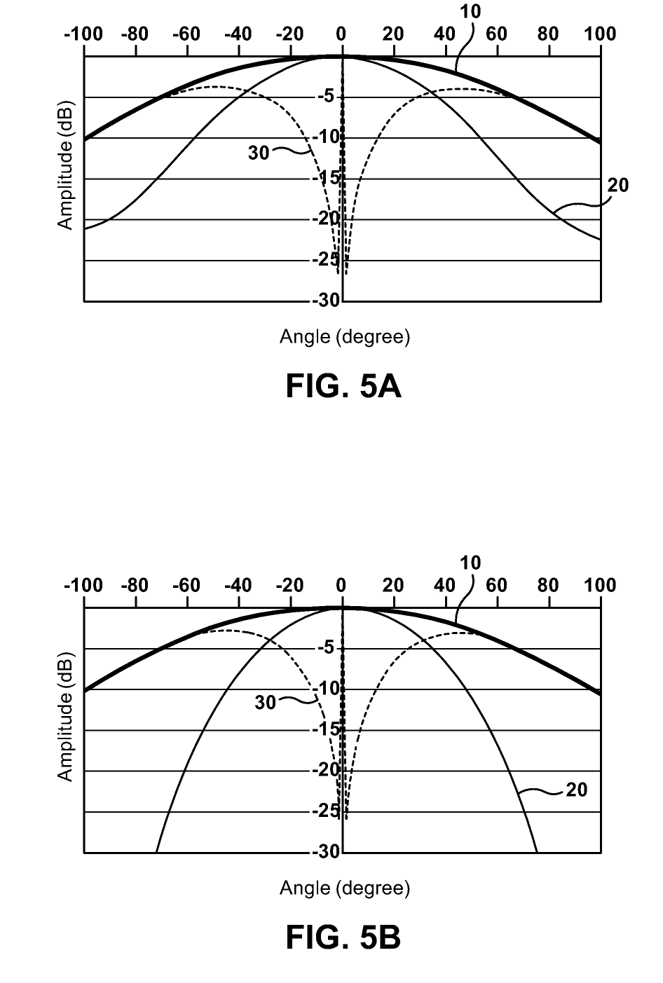

In this comparative example, the distance D between the antenna elements 102 is set to meet D/λ0<0.5 thereby to prevent the directivity of arrangement from becoming zero over the range of ±90°. The arrangement directivity is explained with reference to FIGS. 5(a) and 5(b). In FIGS. 5(a) and 5(b)5, the vertical axis shows the reception level (dB) and the horizontal axis shows the angle from the direction vertical to the antenna plane. An example of the reception pattern of the single antenna element is shown by the reference numeral 10 and examples of the sum signal (Σ) and the difference signals (Δ) of two array antennas are denoted by the reference numerals 20 and 30, respectively. Here, the beam width of the single antenna element is 108°.

In FIGS. 5(a) and 5(b), the distance D between antenna elements is changed, and that is, in FIG. 5(a), D/λ0=0.42 and in FIG. 5(b), D/λ0=0.5. When D/λ0=0.42 is met and the distance D between antenna elements 102 is smaller, the reception level of the sum signal 20 tends to decrease gently over ±90 degrees centered at 0 degree. On the other hand, when D/λ0=0.5 is met, the reception level of the sum signal 20 is decreased rapidly as the angle becomes closer to 90 degrees.

In the phase-comparison monopulse system, the angle is calculated from a value (Δ/Σ) obtained by dividing the difference signal 30 by the sum signal 20. When the reception level of the sum signal 20 becomes closer to zero, the value Δ/Σ becomes increased rapidly and the angle cannot be obtained. This is because when D/λ0 is 0.5 or more, the angle zero is included within the angles of ±90 degrees due to interference of reception signals of the two antennas. Then, in the present radar antenna 100 of this comparative example, the antenna elements 102 are arranged to meet D/λ0<0.5. With this structure, the sum signal Σ is prevented from being zero and angle measurement is allowed over the wide angle range of ±90 degrees.

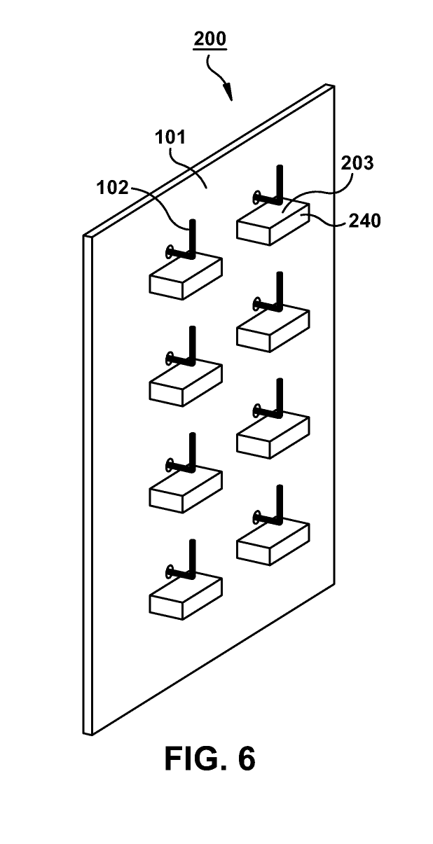

Next description is made about a third comparative example. In the radar antenna 100 shown in FIG. 1 the second ground plate 103 is shaped like a curve surface formed on the cylindrical column. However, the second ground plate 103 is not limited to this shape and may be a flat surface formed on a rectangular column. FIG. 6 shows a radar antenna 200 of the third comparative example having a flat-surface shaped second ground plate formed on the rectangular column. In this figure the flat-surface shaped second ground plate 203 is formed on the rectangular column 240.

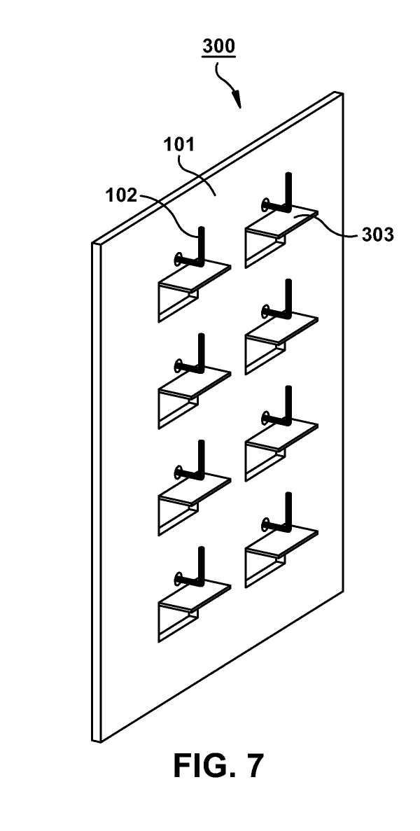

As the fourth comparative example, a radar antenna 300 is shown in FIG. 7, in which the cylindrical column or rectangular column is not used and a partial cut of the first ground plate 101 is used as each second plate. In this figure, parts of the first ground plate 101 are cut and bent to be used as second ground plates 303.

The vertical length of each second ground plate 103 to the first ground plate 101, or the height of the second ground plate 103 from the first ground plate 101 as bottom surface is determined in such a manner that the measurable angle range on the plane containing the antenna elements vertical to the first ground plate 101 (vertical plane in FIG. 1) becomes a given range.

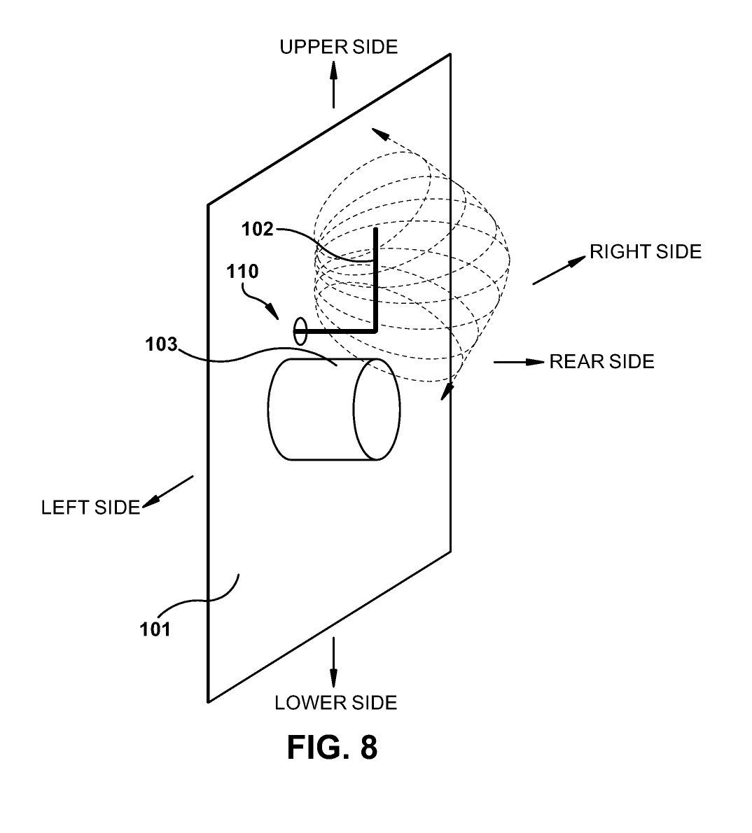

The effect on the radiation pattern by the height of the second ground plate 103 is schematically shown in FIG. 8. The height of each second ground plate 103 affects downward spreading of the radiation pattern in the figure. When the second ground plate 103 is too high, the measurement may not be made back and downward. Hence, the height of the second ground plate 103 can be determined in such a manner as to allow back and downward measurement over desired angle range appropriately.

In the radar antenna 100 shown in FIG. 1, the vertical direction is determined to have each second ground plate 103 placed below the antenna element 102. On the other hand, it is possible that the second ground plate 103 and the antenna element 102 are placed upside down in such a manner that the second ground plate 103 is placed above the antenna element 102. In this case, the upward radiation can be suppressed by increasing the height of the second ground plate 103.

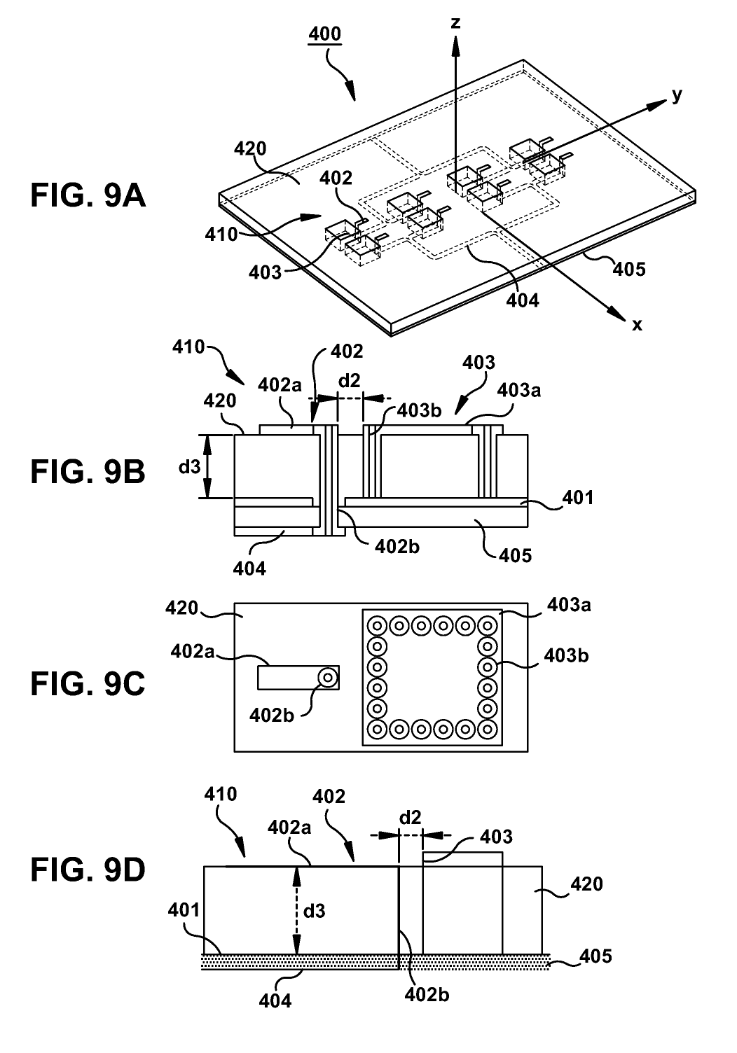

Next description is made about a radar antenna according to the first embodiment of the present invention. In the above-described comparative examples, antenna elements 102 of line conductor are used arranged in the air. In this embodiment, a plurality of antenna units 110 are patterned and formed integrally on a given board. As the antenna unit 110 is pattern-formed integrally, radar antennas can be formed easily. The radar antenna 400 according to the first embodiment of the present invention using a dielectric board is shown in FIGS. 9(a) to 9(d). FIG. 9(a) shows a transparent perspective view of the radar antenna 400 and FIGS. 9(b) to 9(d) schematically show a cross sectional view, a top view and a cross sectional view of each antenna unit 410. The cross sectional views of FIGS. 9(b) and 9(d) are views taken along the plane that passes the center of the antenna element 402 and is vertical to the first ground plate 401.

The radar antenna 400 of this embodiment has formed therein eight antenna units 401 as four by two array on the radiation board 420 made of dielectric material having relative permittivity ε. On the back surface of the radiation board 420, the first ground plate 401 is formed. Further on the first ground plate 401, a line board 405 is provided. On the line board 405, a transmission line 404 is formed.

Each antenna unit 410 has an antenna element 402 and a second ground plate (reflection column) 403. The antenna element 402 is made of a radiation part 402a and a power feeding part 402b. The radiation part 402b is pattern-formed on the radiation board 420 and the power feeding part 402b is formed of a through hole connected to a transmission line 404. The through hole as the power feeding part 402b is formed out of contact with the first ground plate 402. Likewise, the second ground plate 403 can be formed of a through hole 403b and a land 403a pattern-formed on the radiation board 420. The through hole 403b is connected to the first ground plate 401. The land 403a is electrically connected to the plural through holes 403b.

As described above, when the antenna unit 410 is print-formed using the radiation board 420 of dielectric material, if the dimensions of the radiation board 420 are not appropriate, there occurs surface wave, which causes distortion in the radiation pattern. In this case, ambiguity remains in the discrete curve for azimuth measurement with monopulse angle measuring. In order to prevent occurrence of surface wave on the board sufficiently when the transmission and reception wave has a free-space wavelength of λ0, there is need to determine the thickness of the substrate d3 appropriately. Here, the distance d2 between the power feeding part 402b and the second ground plate 403 becomes a matching parameter for adjusting the impedance between the transmission line 404 and the radiation part 402a.

In the first comparative example, the radiation part 102a of the antenna element 102 and the first ground plate 101 are placed in such a manner as to have a distance d1 approximately equal to λ0/4. If the thickness d3 of the board is selected close to λg/4 in like fashion, there may occur surface wave. Here, λg is a TEM mode in-tube wavelength and given by the following equation.

$${λ}_{g} = \frac{λ 0}{\sqrt{{ɛ}_{g}}} \qquad [ Equation 5 ]$$

Next description is made about determination of the thickness d3 of the radiation board 420 so as to prevent occurrence of surface wave on the board in principle.

When the transmission line is a waveguide tube, if the bandwidth is given by a ratio of transmittable frequency upper and lower limits, it becomes about 1.5. On the other hand, when the transmission line is a coaxial cable or micro strip, there is no lower cutoff frequency and there exists a higher mode. Hence, when the thickness d3 of the radiation board 420 is increased, the higher mode appears to affect the antenna performance and discrete curve adversely. As the higher mode of micro trip line, there is TE surface wave. When a surface wave cutoff frequency of the radiation board 420 is fc, fc is give by the following equation.

$$fc = \frac{c}{4 d 3 \sqrt{ɛ r - 1}} \qquad [ Equation 6 ]$$

where c denotes light velocity. One example, for a FR material having εr=4.4, if d3=1.3 mm is met, fc becomes 3102 GHz, and when d3=0.9 mm is met, fc becomes 45.2 GHz.

Occurrence of surface wave due to energy of transmission and reception wave input to the antenna element 402 is made when the use frequency f becomes equal to or more than the above-mentioned surface wave cutoff frequency fc. In this case, there occurs TE surface wave, the energy input to the antenna element 402 propagates as surface wave in the radiation board 420, which causes propagation loss, resulting in deterioration of antenna radiation performance such as gain and occurrence of ambiguity in discrete curve for azimuth measurement with monopulse angle measuring to reduce measurement accuracy.

Then, in order to suppress occurrence of surface wave, it is necessary to make the use frequency f smaller than the surface wave cutoff frequency fc (f<fc) and to determine the thickness d3 of the radiation board 420 in such a manner as to meet the following equation. That is, from calculation of the equations (6) and (7), d3 needs to satisfy the following equation (8).

$$\begin{matrix}f = \frac{c}{λ} < fc & [ Equation 7 ] \\ d 3 < \frac{λ}{4 \sqrt{ɛ r - 1}} & [ Equation 8 ]\end{matrix}$$

When β=fc/f is met, β>1 is established from the equation (7) and the equations (6), (7) and (8) are used to express the thickness d3 by the following equation (9).

$$d 3 = \frac{λ}{4 β \sqrt{ɛ r - 1}} \qquad [ Equation 9 ]$$

The following description is made about a value of β that satisfies β>1.

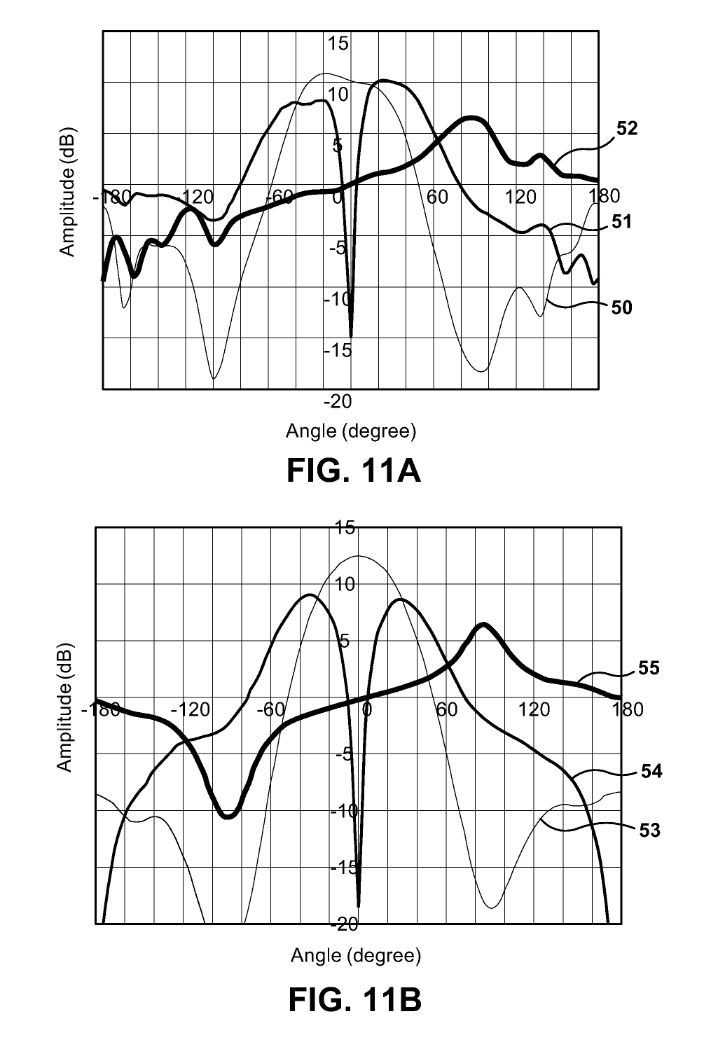

When the value of β is increased, d3 gets smaller from the equation (9) and the radiation part 402a is made closer to the first ground plate 401. When β is increased extremely and the radiation part 402a is too close to the first ground plate 401, there occurs mirror image current in the first ground plate 401, resulting in deterioration of antenna radiation performance such as gain. On the other hand, when β is made closer to 1, there begins to occur effects due to the surface wave. It is necessary to determine an optimal value of β in view of such characteristics. As one example of study results, the radiation pattern simulation results are shown in FIG. 11 for the monopulse antenna having horizontally two by vertically four arranged elements like the radar antenna 100 of the first comparative example. The radiation board 420 used here is FR4.

FIGS. 11(a) and 11(b) show radiation patterns of d3=1.3 mm and d3=0.9 mm, respectively. Here, 50 and 53 denote sum patterns (Σ), 51 and 54 denote difference patterns (Δ) and 52 and 55 denote discrete curves. When the relative permittivity of the FR4 used in the radiation board 420 is 4, and the frequency f=26.5 GHz, λ0=11.3 mm is obtained. With use of this, β can be calculated from the equation (9). That is, β is 1.18 for d3=1.3 mm and β is 1.70 for d3=0.9 mm. Seen from FIG. 11(a) and 11(b), the case of (a) d3=1.3 mm exhibits deterioration in symmetric property of both of the sum pattern and difference pattern. This means that β is preferably about 1.7.

Besides, FIG. 11(a) shows the discrete curve (Δ/Σ) 52 obtained by dividing the difference pattern 51 by the sum pattern 50, and FIG. 11(b) shows the discrete curve (Δ/Σ) 55 obtained by dividing the difference pattern 54 by the sum pattern 53. These discrete curves 52 and 55 also show different effects of the surface wave. That is, for the case of (a) d3=1.3 mm, there appear ripples at angles of about 20° to 40°, around 140° around −20° and around −160°. In vicinity of these ripples, change in Δ/Σ relative to the angle is small, or the discrete curve does not show one-to-one correspondence but ambiguity for the angle. On the other hand, for the case of (b) d3=0.9 mm, there appear no ripple like in FIG. 11(a), and the curve is smooth. This exhibits that the case of d3=0.9 mm, that is β=about 1.7 is preferable.

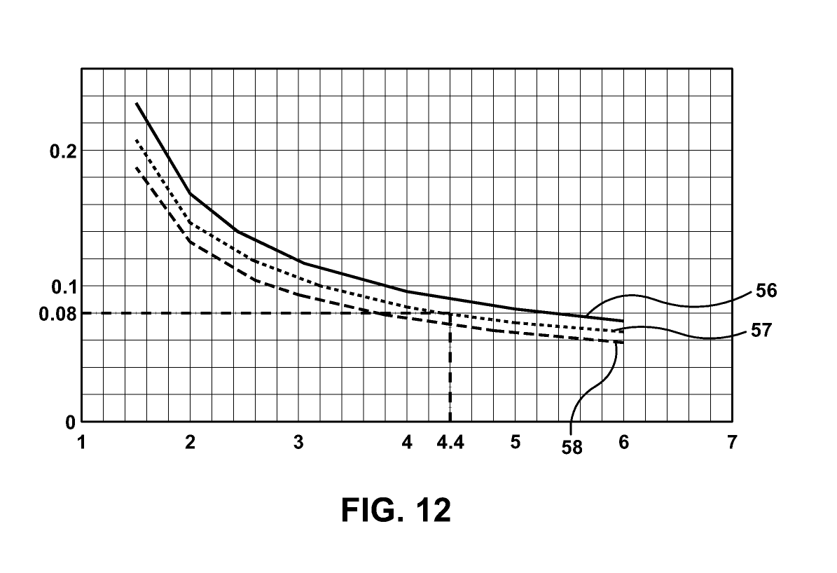

Further, when the relative permittivity εr of the radiation board 420 is a variant and β is a parameter, d3/λ0 is calculated from the equation (9), which results are shown in FIG. 12. In FIG. 12, reference numerals 56, 57, 58 denotes the cases of β=1.5, 1.7 and 1.9, respectively. As one example, when β=1.7 is given and the relative permittivity εr of the radiation board 420 is 4.4, the line 57 in FIG. 12 is used to obtain d3/0=0.08. Here, when the use frequency f=26.5 GHz, the free space wavelength λ0=11.312 mm is given and the thickness d3 of the radiation board 420 becomes 0.904 mm (d3=0.08×11.312=0.904). With use of FIG. 12, the appropriate thickness d3 of the radiation board 420 for the relative permittivity εr can be selected. As the range of preferable values of β, β is preferably equal to or more than 1.2, more preferably equal to or more than 1.6 and equal to or less than 1.8. When the value of β is further increased, enough gain cannot be obtained.

Next description is made about an appropriate value of the length L of the radiation part 402a pattern-formed on the radiation board 420. As expressed by the following equation, the length L is preferably determined in such a manner as to be approximately equal to one fourth of the equivalent wavelength λeff obtained during operation as the micro strip line.

$$L \approx \frac{λ eff}{4} = \frac{λ}{4 \sqrt{ɛ eff}} \qquad [ Equation 12 ]$$

where εeff denotes an effective relative permittivity or the dielectric material of the radiation board 420 and is given by the following equation with use of the width w of the radiation part 402a.

$$ɛ eff = \frac{ɛ r + 1}{2} + \frac{ɛ r - 1}{2 \sqrt{1 - 10 d 3 / w}} \qquad [ Equation 13 ]$$

As one example, when the width of the antenna element 102 w is 0.6 mm, the thickness d3 of the radiation board 420 is 0.9 mm, and the relative permittivity εr is 4.4, the effective relative permittivity εeff becomes εeff=3.571 from the equation (13). With this calculation, the length L of the radiation part 402a of the antenna element 402 ranges from 1.496 mm to 1.5 mm from the equation (12).

In the first comparative-example radar antenna 100 having antenna elements 102 each formed by arranging line conductor in air, in order that the second ground plate (reflective column) 103 functions as a ground, its height is preferably increased, but if it is too high, there is a problem of incapability of back and downward measurement. Also in the radar antenna 400 of this embodiment having the antenna elements 402 and the second ground plate 403 pattern-formed integrally on the radiation board 420, it is effective that each second ground plate 403 is higher than the power feeding part 402b. That is, when the height of the second ground plate 403 is h, it is preferable to determine α as a smaller value that meets the following equation. This selection of α enables optimization of the radiation pattern of the antenna elements 402.

h=d3+α(α≧0) [Equation 14]

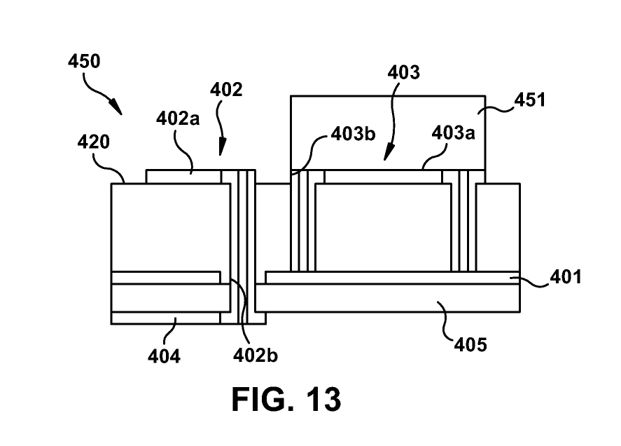

Next description is made, with reference to FIG. 13, about a radar antenna according to another embodiment having second ground plates higher than power feeding parts 402b. FIG. 13 is a cross sectional view of one antenna unit 450 of the radar antenna according to the second embodiment. Like in FIG. 9(b), this cross sectional view of FIG. 13 is taken along the plane that passes through the center of the antenna element 402 and is vertical to the first ground plate 401. The antenna unit 450 is structured to have a reflector 451 arranged on an upper surface of the second ground plate 403 of the antenna unit 410 of the first embodiment. As the reflector is placed on the second ground plate 403 printed and integrally formed on the radiation board 420, the height of the second ground plate is further increased. The radiation pattern of the antenna element 402 can be optimized by selecting the height of the reflector 451 in such a manner as to meet the equation (14).

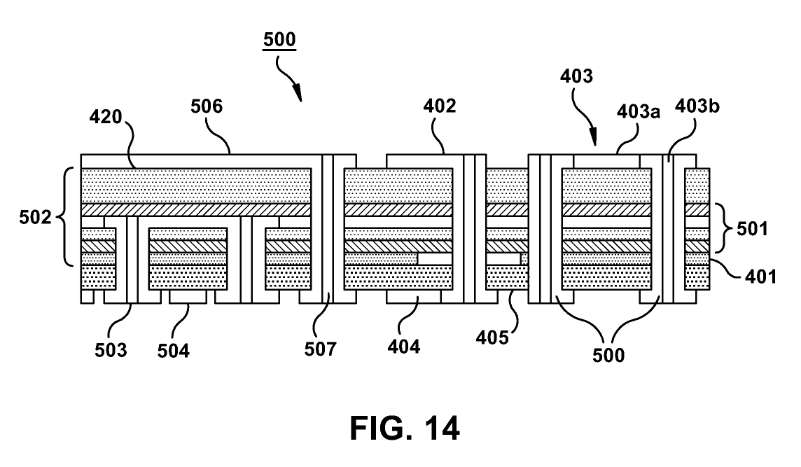

A radar antenna according yet another embodiment of the present invention is described with reference to FIG. 14. FIG. 14 is a partial cross sectional view of a radar antenna 500 according to the third embodiment, taken along the plane that passes through the center of the antenna element 402 and is vertical to the first ground plate 401. In the radar antenna according to the above-described first and second embodiments, the radiation board 420 is formed of one-layer dielectric board, the first ground plate 401 is formed on the back surface that is opposite to the surface where the radiation part 402a is formed, and the line board 405 is further arranged on the first ground plate 401.

On the other hand, in the radar antenna 500 of this embodiment, formed on a back surface of the radiation board 420 are another dielectric board 501 made of one or more layers and a radiation part board 502 made of two or more dielectric boards. The board having such a layer structure can be used divided by given shield means. In the dielectric board 501, a pattern and through holes are formed to provide circuit, line and the like, and given shield means is used to prevent propagation of noise to or from the antenna elements 402. This shield means also can be formed by a pattern and through hole. In the embodiment shown in FIG. 14, the pattern 506 is formed for shielding electromagnetic effect from the radiation board 420 direction and a through hole 507 is formed for preventing propagation of noise between the antenna element 402 and the lines or the like formed on the dielectric board 501. With this structure, it is possible to form necessary elements, lines and the like with pattern and through holes, and the printed wiring technique is applied thereby to facilitate manufacturing of the radar antenna 500.

In this embodiment, the dielectric board 501 made of one or more layers is provided thereby to enhance the degree of freedom in circuit designing such as forming of given circuits in each layer. For example, a through hole 403b for forming the second ground plate 403 can be connected to a third ground plate 505 that is different from the first ground plate 401. In addition, in FIG. 14, the dielectric board 501 layer is used to form the bias line 503, which may be utilized to provide another micro strip line 504. The bias line 503 and the micro strip line 504 are shielded from the antenna element 402 by the pattern 506 and the through hole 507. The line board 405 having high-frequency transmission line 404 needs to be formed of a Rogers board or the like that exhibits less line loss, however the dielectric board 501 may be formed of inexpensive FR4 board. Besides, the radiation board 420 may be formed of Rogers board or FR4 board.

Here, the description of this embodiment was made for showing an example of a radar antenna according to this invention and is not for limiting the present invention. The structure of details of the radar antenna of this embodiment, detailed operation and the like can be modified if necessary without departing from the scope of this invention.

What is claimed is:

1. A radar antenna comprising:
a radiation board having a thickness of d3;
a straight radiation part formed on one surface of the radiation board;
a first ground plate formed on an opposite surface of the radiation board;
a power feeding part formed passing perpendicularly through the radiation board, electrically connected to the radiation path and being out of contact with the first ground plate;
a second ground plate formed in parallel with the power feeding part, a predetermined distance away from the power feeding part and extending from the one surface to the first ground plate; and
the radiation part and the power feeding part forming an antenna element.

2. The radar antenna of claim 1, wherein when a free space wavelength of transmission/reception wave is λ0, a relative permittivity of the radiation board is εr, an effective relative permittivity of the radiation board is εeff and a width of the radiation part is w, a length of the radiation part satisfies equations (1) and (2).
$$\begin{matrix}L \approx \frac{λ eff}{4} = \frac{λ 0}{4 \sqrt{ɛ eff}} & ( Equation 1 ) \\ ɛ eff = \frac{ɛ r + 1}{2} + \frac{ɛ r - 1}{2 \sqrt{1 - 10 d 3 / w}} & ( Equation 2 )\end{matrix}$$

3. The radar antenna of claim 1, wherein the antenna element and the second ground plate form one antenna unit, the antenna unit comprises two antenna units arranged on the radiation board, and a distance between two antenna elements meets D/λ<0.5.

4. The radar antenna of claim 3, wherein a plurality of antenna units are arranged and arrayed in a direction orthogonal to an arrangement direction of the two antenna units.

5. The radar antenna of any one of claims 1, further comprising:
a line board having one surface adhered to an surface of the first ground plate opposite to a surface in contact with the radiation board;
a transmission line formed on an opposite surface of the line board; and
the through hole of the power feeding part passing perpendicularly through the line board and electrically connecting the radiation part to the transmission line.

6. The radar antenna of any one of claims 1, wherein the thickness d3 of the radiation board satisfies an equation (3).
$$d 3 < \frac{λ}{4 \sqrt{ɛ r - 1}} \qquad ( Equation 3 )$$

7. The radar antenna of any one of claims 1, wherein the thickness d3 of the radiation board is expressed by an equation (4), β satisfies 1.6<β<1.7.
$$d 3 = \begin{matrix}λ 0 \\ 4 β \sqrt{ɛ r - 1}\end{matrix} \qquad ( Equation 4 )$$

8. The radar antenna of any one of claims 1, wherein the second plate has a land formed on the one surface of the radiation board and a through hole row having a plurality of through holes passing through the radiation board and electrically connecting the first ground plate and the land, and the through hole row is arranged the predetermined distance away from the power feeding part.

9. The radar antenna of claim 8, wherein the second ground plate has other plural through holes arranged into a ring shape farther from the power feeding part than the through hole row.

10. The radar antenna of any one of claims 1, wherein the second ground plate has a part formed on the one surface of the radiation board having a height of α(≧0) and a height of the second ground plate from the first ground plate h is d3+α.

11. The radar antenna of any one of claims 1, further comprising one or more boards between the radiation board and the line board, the one or more boards being stacked into a layer and having a bias line formed therein.

12. The radar antenna of claim 11, further comprising:
another through hole row formed like a blind between the bias line and the antenna element;
a sheet metal covering a surface of the radiation board positioned at a top of a bias layer where the bias line is arranged; and
the through hole row and the sheet metal being electrically connected to reduce interference between the antenna element and the bias line.
